(19) United States
(12) Patent Application Publication
(10) Pub. No.: US 2022/0311320 A1
(43) Pub. Date: Sep. 29, 2022

(54) LINEAR VIBRATION MOTOR, ELECTRONIC DEVICE USING LINEAR VIBRATION MOTOR, VIBRATOR, AND METHOD OF MANUFACTURING VIBRATOR

(71) Applicant: Murata Manufacturing Co., Ltd., Nagaokakyo-shi (JP)

(72) Inventors: Takeshi KURITA, Nagaokakyo-shi (JP); Keiji FUJIOKA, Nagaokakyo-shi (JP); Kazuhide TAKATA, Nagaokakyo-shi (JP)

(21) Appl. No.: 17/841,050

(22) Filed: Jun. 15, 2022

Related U.S. Application Data
(63) Continuation of application No. PCT/JP2020/033657, filed on Sep. 4, 2020.

(30) Foreign Application Priority Data
Jan. 30, 2020 (JP) 2020-013826

(51) Int. Cl. H02K 33/18; B06B 1/04

(52) U.S. Cl. CPC H02K 33/18; B06B 1/045

(57) ABSTRACT

A linear vibration motor is provided that includes a housing, a vibrator, and a coil. The vibrator includes a weight portion and a first magnet, and the vibrator is accommodated inside the housing. The weight portion includes a multilayer body in which multiple sheets including metal sheets are laminated in a thickness direction. The multilayer body has a first principal surface and a second principal surface opposite to the first principal surface, and a first accommodation section is formed in the multilayer body so as to open at the first principal surface and at the second principal surface. The first magnet is fixed in the first accommodation section and the coil is fixed to the housing so as to oppose the first magnet. In addition, an electronic device is provided that uses the linear vibration motor. A vibrator and a method of manufacturing the vibrator is also provided.

### CROSS REFERENCE TO RELATED APPLICATIONS

This application is a continuation of PCT Application No. PCT/JP2020/033657, filed Sep. 4, 2020, which claims priority to Japanese Patent Application No. 2020-013826, filed Jan. 30, 2020, the entire contents of each of which are hereby incorporated in their entirety.

### TECHNICAL FIELD

The present disclosure relates to a linear vibration motor, an electronic device using the linear vibration motor, a vibrator, and a method of manufacturing the vibrator.

### BACKGROUND

Currently, an electronic device, such as a portable information terminal, may include a linear vibration motor. The linear vibration motor serves as a vibration generating device for providing cutaneous sensation feedback or for confirming keystrokes or noticing incoming calls using vibration. An example of the linear vibration motor is disclosed in U.S. Patent Application Publication No. 2016/0226361 (hereinafter “Patent Document 1”). FIG. 14 is a cross-sectional view illustrating the linear vibration motor described in Patent Document 1.

As shown, a linear vibration motor 300 includes a housing 301, a vibrator 302, a coil 303, a first guide 304 and a second guide 305. The vibrator 302 includes a weight portion 302a, a first magnet M301, a second magnet M302, and a third magnet M303. The first magnet M301, the second magnet M302, and the third magnet M303 are fixed to the weight portion 302a. The housing 301 has a fourth magnet M304 and a fifth magnet M305 fixed thereto.

As described in Patent Document 1, the vibrator 302 is driven by the coil 303 and the first magnet M301, which serves as a driving magnet, to vibrate in the first direction D1 along the first guide 304 and the second guide 305 that guide the movement of the vibrator 302. The second magnet M302 and the fourth magnet M304 are disposed side by side in the first direction D1 so as to magnetically repel each other, and the third magnet M303 and the fifth magnet M305 are disposed in the same manner. In other words, a pair of the second magnet M302 and the fourth magnet M304 and a pair of the third magnet M303 and the fifth magnet M305 form a magnetic spring mechanism against vibration of the vibrator 302 in the first direction D1.

Moreover, the magnetic spring mechanism transmits the vibration of the vibrator 302 to the housing 301 via the fourth magnet M304 and the fifth magnet M305, which causes the linear vibration motor 300 to vibrate.

The weight portion 302a is presumably manufactured using the powder metallurgy method, although it is noted that Patent Document 1 does not describe this explicitly. For example, Japanese Unexamined Patent Application Publication No. 2018-3135 (hereinafter “Patent Document 2”) discloses that a vibrator of a vibration motor is manufactured using the powder metallurgy method.

In addition, electronic devices, such as portable information terminals, have been subjected to thickness reduction in recent years. In this circumstance, thickness reduction of the linear vibration motor is demanded so that the linear vibration motor can be disposed in a thinner electronic device. One way of reducing the thickness of the linear vibration motor is to reduce the thickness of the vibrator. In doing so, it is necessary to reduce the thickness of the weight portion. However, it may be difficult to produce thinner weight portions when using the powder metallurgy method, which may make it difficult to produce thinner vibrators.

### SUMMARY OF THE INVENTION

Accordingly, it is an object of the present disclosure to provide a linear vibration motor that can be made thin, an electronic device that uses the linear vibration motor, a vibrator that can be made thin, and a method of manufacturing the vibrator.

In an exemplary aspect, a linear vibration motor is provided that includes a housing and a vibrator. The vibrator includes a weight portion and is accommodated inside the housing. Moreover, the weight portion includes a multilayer body having a first principal surface and a second principal surface opposite to the first principal surface. The multilayer body has multiple sheets laminated in a thickness direction, with the multiple sheets including at least one metal sheet.

In another exemplary aspect, an electronic device is provided that includes the linear vibration motor according to the present disclosure and a device housing. The linear vibration motor is accommodated inside the device housing.

In yet another exemplary aspect, a vibrator is provided that includes a weight portion. The weight portion includes a multilayer body having a first principal surface and a second principal surface opposite to the first principal surface. The multilayer body has multiple sheets laminated in a thickness direction, with the multiple sheets including at least one metal sheet.

Yet further, a method of manufacturing the vibrator is provided according to an exemplary aspect. In particular, a method of manufacturing a vibrator is provided that includes a step of providing multiple sheets that include at least one metal sheet. The method also includes a step of laminating the multiple sheets in a thickness direction and thereby forming a weight portion that includes a multilayer body having a first principal surface and a second principal surface opposite to the first principal surface.

According to the exemplary aspects, the linear vibration motor can be made thin since the linear vibration motor includes the vibrator having the weight portion configured as above. The electronic device of the present disclosure uses the linear vibration motor of the present disclosure and accordingly can be made thin. Similarly, the vibrator of the present disclosure can be made thin since the thickness of the weight portion can be reduced. According to the method of manufacturing the vibrator of the present disclosure, the vibrator having the thinner weight portion can be manufactured.

### BRIEF DESCRIPTION OF DRAWINGS

FIG. 1 is a perspective view illustrating a linear vibration motor 100 that represents a schematic form of the linear vibration motor according to the present disclosure.

FIG. 2 is an exploded perspective view illustrating the linear vibration motor 100.

FIG. 3 is a perspective view illustrating a first exemplary embodiment of a multilayer body 2a included in a vibrator 2 of the linear vibration motor 100.

FIG. 4 is an exploded perspective view illustrating the first exemplary embodiment of the multilayer body 2a.

FIG. 5 is a perspective view illustrating a second exemplary embodiment of the multilayer body 2a included in the vibrator 2 of the linear vibration motor 100.

FIG. 6 is an exploded perspective view illustrating the second exemplary embodiment of the multilayer body 2a.

FIG. 7 is a perspective view illustrating a third exemplary embodiment of the multilayer body 2a included in the vibrator 2 of the linear vibration motor 100.

FIG. 8 is an exploded perspective view illustrating the third exemplary embodiment of the multilayer body 2a.

FIG. 9 is a perspective view illustrating a fourth exemplary embodiment of the multilayer body 2a included in the vibrator 2 of the linear vibration motor 100.

FIG. 10 is an exploded perspective view illustrating the fourth exemplary embodiment of the multilayer body 2a.

FIG. 11 is a cross-sectional view of a linear vibration motor 100A that represents another schematic form of the linear vibration motor according to the present disclosure.

FIG. 12(A) is a perspective view schematically illustrating a step of manufacturing a metal sheet 2a₁ having a first pattern. FIG. 12(B) is a perspective view schematically illustrating a step of manufacturing a metal sheet 2a₃ having a second pattern. FIG. 12(C) is a side view schematically illustrating metal sheets 2a₁ to 2a₆ manufactured in the steps of FIGS. 12(A) and 12(B). FIG. 12(D) is a side view schematically illustrating a step of manufacturing the multilayer body 2a by laminating the metal sheets 2a₁ to 2a₆.

FIG. 13 is a transparent perspective view of a portable information terminal 1000 that represents a schematic form of the electronic device according to the present disclosure.

FIG. 14 is an exploded perspective view illustrating a known linear vibration motor 300.

### DETAILED DESCRIPTION OF EMBODIMENT

Features of the present disclosure will be described with reference to the drawings. It is noted that in the schematic forms and embodiments of a linear vibration motor described herein, the same or common components illustrated in the drawings are denoted by the same reference signs, and the descriptions thereof are not necessarily duplicated.

Schematic Form of Linear Vibration Motor

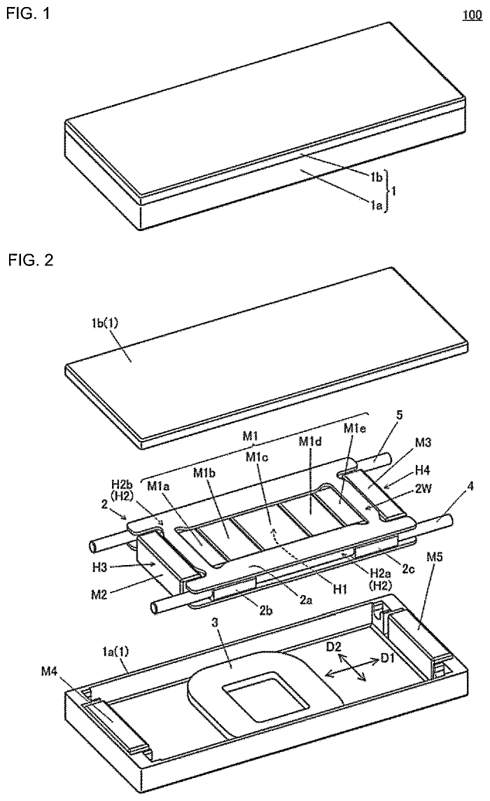

In general, a linear vibration motor 100, which represents a schematic form of the linear vibration motor according to the present disclosure, will be described with reference to FIGS. 1 and 2. FIG. 1 is a perspective view of the linear vibration motor 100. FIG. 2 is an exploded perspective view of the linear vibration motor 100.

As illustrated in FIGS. 1 and 2, the linear vibration motor 100 includes a housing 1, a vibrator 2, a coil 3, a first shaft 4 and a second shaft 5, a fourth magnet M4, and a fifth magnet M5. Moreover, the vibrator 2 includes a weight portion 2W, a first magnet M1, a second magnet M2, and a third magnet M3. The housing 1 includes a container 1a and a top board 1b. It is noted that extension wires from the coil 3 are not illustrated in the drawings. In operation, the vibrator 2 is configured to vibrate in the first direction D1.

In an exemplary aspect, the container 1a of the housing 1 includes a bottom board extending in the first direction D1 and sides extending vertically from the bottom board. In other words, the bottom board and the sides of the container 1a form a space in which the vibrator 2 is accommodated, and the top board 1b serves as a lid for covering the space. The top board 1b is joined to the edges of respective sides of the container 1a. That is, the housing 1 has a sealed structure when the top board 1b is joined to the container 1a. An opening, however, can be formed at at least one of part of the bottom board and part of the sides.

The housing 1 includes a fixation portion, of which the illustration is omitted. The fixation portion is used when the housing 1 is fixed to an electronic device, such as a portable information terminal, which will be described later. In an exemplary aspect, the housing 1 can be made of a stainless steel, an example of which is SUS 304. It is noted that the container 1a and the top board 1b can be made of different materials.

The coil 3 is formed by winding a conducting wire about an imaginary winding axis. The coil 3 is fixed in the container 1a of the housing 1 in such a manner that the winding axis extends orthogonal both to the first direction D1 and to a second direction D2 that extends parallel to the bottom board and orthogonal to the first direction D1 and in such a manner that the coil 3 opposes a first magnet M1, which will be described later. The coil 3 of the linear vibration motor 100 is shaped like a rectangle with rounded corners when the coil 3 is viewed in the direction along the winding axis.

For example, the coil 3 is formed by winding a 0.06 mm diameter covered copper wire about 50 turns. The coil 3 is coupled to a stabilized power supply via a power amplifier using an extension wiring member (not illustrated), such as a flexible circuit in which a wiring pattern is printed. Energizing the coil 3 through the extension wiring member generates a drive force to act on the first magnet M1 (which will be described later), which enables the vibrator 2 to vibrate in the first direction D1. It is noted that the winding of the coil 3 is not illustrated in FIG. 2.

Due to the presence of the magnetic field of the first magnet M1, when the electric current flows through the coil 3, a Lorentz force acts on the coil 3 in a direction orthogonal to both directions of the magnetic field and the electric current. Since the coil 3 is fixed to the housing 1 (e.g., container 1a), a reaction force caused by the Lorentz force acts on the first magnet M1. Accordingly, the energized coil 3 imparts the drive force to the first magnet M1, and thereby to the vibrator 2, in the first direction D1. In other words, the first magnet M1 serves as a driving magnet in the linear vibration motor 100.

As described above, the coil 3 has a rectangular shape as viewed in the winding axis direction. In this case, the direction of the Lorentz force tends to align the first direction D1 compared with a case of the coil 3 having a circular shape. This configuration increases the driving force acting on the vibrator 2 in the first direction D1, which is preferable.

As further shown, both the first shaft 4 and the second shaft 5 extend in the first direction D1. The first shaft 4 and the second shaft 5 are disposed parallel to each other in a second direction D2, which is a direction parallel to the bottom board and orthogonal to the first direction D1. The first shaft 4 and the second shaft 5 support the vibrator 2 so as to configure and enable the vibrator 2 to vibrate in the first direction D1. In an exemplary aspect, the first shaft 4 and the second shaft 5 can be made of a stainless steel, an example of which is SUS304.

The first shaft 4 and the second shaft 5 are fixed to, and suspended between, two of the sides of container 1a that oppose each other in the first direction D1. Each end portion of the first shaft 4 and the second shaft 5 is fitted in a recess formed in the corresponding one of the two sides. The method of fixation of the shafts to the sides is not limited to this. Each shaft may be fixed to the bottom board, for example, using a separate member.

The fourth magnet M4 is fixed to one of the two sides of the container 1a in such a manner that the orientation of the magnetic poles is aligned with the first direction D1, whereas the fifth magnet M5 is fixed to the other one of the two sides in the same manner. The fourth magnet M4 and the fifth magnet M5 are fitted in recessed sections formed in respective sides of the two sides. The fourth magnet M4 and the fifth magnet M5 can be fixed in the recessed sections, for example, using an epoxy-based adhesive.

### First Exemplary Embodiment of Multilayer Body Included in Vibrator of Linear Vibration Motor

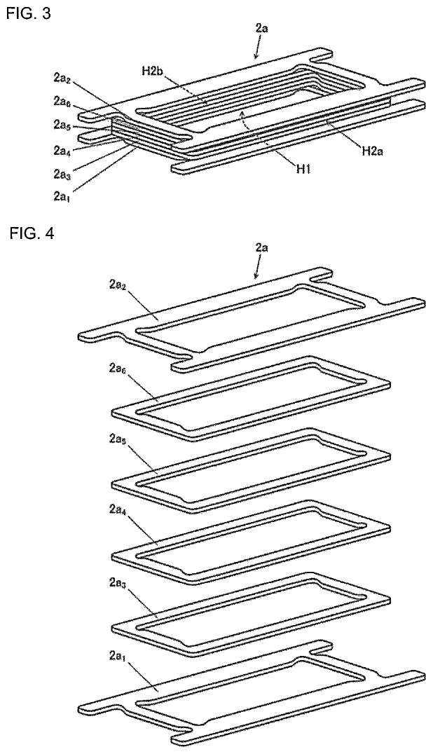

A first exemplary embodiment of a multilayer body 2a included in the vibrator 2 of the linear vibration motor 100 will be described with reference to FIGS. 3 and 4. FIG. 3 is a perspective view illustrating the first embodiment of the multilayer body 2a included in the vibrator 2 of the linear vibration motor 100. FIG. 4 is an exploded perspective view illustrating the first embodiment of the multilayer body 2a.

The vibrator 2 is accommodated in the above-described space in the housing 1. The vibrator 2 includes the weight portion 2W, the first magnet M1, the second magnet M2, and the third magnet M3. The weight portion 2W includes the multilayer body 2a having a first principal surface and a second principal surface being opposite to the first principal surface. Moreover, the weight portion 2W includes a first sleeve 2b and a second sleeve 2c for engaging the vibrator 2 with the first shaft 4 and also includes other sleeves (not illustrated) for engaging the vibrator 2 with the second shaft 5. It is noted that the engagement between the vibrator 2 and the shafts, however, is not limited to the above structure using the sleeves.

As illustrated in FIGS. 3 and 4, the multilayer body 2a included in the weight portion 2W is formed by laminating metal sheets 2a₁ to 2a₆ on each other in the thickness direction (e.g., in a vertical direction of the multilayer body 2a in which the metal sheets 2a₁ to 2a₆ are stacked). The metal sheet 2a₁ has a first pattern and is disposed as the outermost layer of the multilayer body 2a at the first principal surface. The metal sheet 2a₂ also has the first pattern and is disposed as the outermost layer of the multilayer body 2a at the second principal surface. As illustrated in FIG. 3, the first principal surface of the multilayer body 2a is positioned at the bottom of the multilayer body 2a, and as illustrated in FIG. 2, the first principal surface of the multilayer body 2a opposes the coil 3. According to an exemplary aspect, the metal sheet is a thin plate that is made of a metal and does not contain a resin component.

The metal sheets 2a₃ to 2a₆ have a second pattern and are sandwiched between the metal sheets 2a₁ and 2a₂. Note that the number of the metal sheets having the second pattern is not limited to four. Here, the first pattern and the second pattern refer to the shapes of the outer periphery of the metal sheet.

The area defined by the outer periphery of each of the metal sheets 2a₁ and 2a₂ having the first pattern is greater than the area defined by the outer periphery of each of the metal sheets 2a₃ to 2a₆ having the second pattern. For example, the thickness of each of the metal sheets 2a₁ and 2a₂ having the first pattern is 0.15 mm, whereas the thickness of each of the metal sheets 2a₃ to 2a₆ having the second pattern is 0.20 mm. Moreover, the metal sheets 2a₁ to 2a₆ can be cut out from a base material in an exemplary aspect.

For example, the material of the metal sheets 2a₁ to 2a₆ may be tungsten or an alloy containing tungsten, a stainless steel such as SUS304, or aluminum or an alloy containing aluminum. The material of the weight portion 2W is preferably made of a material having a greater specific gravity, such as tungsten or an alloy containing tungsten, which can increase the mass of the vibrator 2 and thereby transfer larger vibrations to the housing 1 via a magnetic spring mechanism, which will be described later. The metal sheets 2a₁ to 2a₆ can be adhered to each other, for example, using an epoxy-based adhesive. The weight portion 2W may also include a weight member other than the multilayer body 2a.

Each of the metal sheets 2a₁ and 2a₂ having the first pattern is a frame that has a piercing section formed in a central portion thereof and has projections. The projections are shaped such that two segments of the frame extending in the first direction D1 protrude beyond the other two segments of the frame extending in the second direction D2. Each of the metal sheets 2a₃ to 2a₆ having the second pattern is a frame that has the piercing section formed in a central portion thereof and has the outer periphery shaped like a rectangle. In the second direction D2, the width of each of the metal sheets 2a₁ and 2a₂ having the first pattern is greater than the width of each of the metal sheets 2a₃ to 2a₆ having the second pattern.

The metal sheets 2a₁ to 2a₆ having the above shapes are laminated to form the multilayer body 2a that has a first accommodation section H1, or the piercing section, that opens at the first and second principal surfaces. In the case of the metal sheets 2a₁ and 2a₂ having the first pattern, the metal sheet 2a₂ does not necessarily have the piercing section formed in the central portion. Alternatively, the metal sheets 2a₃ to 2a₆ having the second pattern may include a metal sheet in which the piercing section is not formed. In other words, the first accommodation section H1 may have at least one opening at the first principal surface of the multilayer body 2a.

The multilayer body 2a also has second accommodation sections H2 formed by laminating the metal sheets 2a₁ to 2a₆. The second accommodation sections H2 have groove-like shapes formed at respective sides of the multilayer body 2a, the sides extending in the first direction D1. The second accommodation sections H2 include an accommodation section H2a formed at one side of the multilayer body 2a and another accommodation section H2b formed at the other side of the multilayer body 2a.

Moreover, the multilayer body 2a has a third accommodation section H3 and a fourth accommodation section H4 formed by laminating the metal sheets 2a₁ to 2a₆. The third accommodation section H3 is formed at one end of the multilayer body 2a in the first direction D1, and the fourth accommodation section H4 is formed at the other end of the multilayer body 2a. In the multilayer body 2a, the third accommodation section H3 and the fourth accommodation section H4 are pierced through the multilayer body 2a from the first principal surface to the second principal surface, but the shapes of the third accommodation section H3 and the fourth accommodation section H4 are not limited to these. The shape of the metal sheets disposed as the outermost layers of the multilayer body 2a at the first and second principal surfaces and the shape of the metal sheets sandwiched therebetween are not limited to the above. For example, all of the metal sheets 2a₁ to 2a₆ can have the same shape in an exemplary aspect.

It is sufficient that the multilayer body 2a is formed at least by laminating multiple sheets that include metal sheets. The multiple sheets may include metal sheets, sheets made of a metallic composite material of metal powder and resin, sheets made of a ceramic composite material of ceramic powder and resin, or resin-containing sheets made of a resin containing no metal powder nor ceramic powder. For example, the metal sheets can be disposed as the outermost layers of the multilayer body 2a at the first and second principal surfaces, and the resin-containing sheets may be disposed between the outermost layers. The multiple sheets are laminated and joined to each other, for example, using an adhesive, but the method of joining of the multiple sheets is not limited to the using of an adhesive and spot welding can be used in an alternative aspect, for example.

The metal powder of the resin-containing sheets may be made of tungsten or an alloy containing tungsten, a stainless steel such as SUS304, or aluminum or an alloy containing aluminum. It is preferable to use a material having a greater specific gravity, such as tungsten or an alloy containing tungsten. For example, the resin may be an olefinic thermo-plastic elastomer. Particle shapes of the metal powder are not specifically limited here.

As described above, the multilayer body 2a has the first accommodation section H1, which is the piercing section that opens at both first and second principal surfaces. The first magnet M1 is accommodated in the first accommodation section H1 so as to oppose the coil 3, which will be described later. The first magnet M1 is fixed using, for example, an epoxy-based adhesive. In the case of the first magnet M1 being accommodated in the first accommodation section H1, in other words, in the case of the thickness of the first magnet M1 being smaller than that of the multilayer body 2a, the thickness of the first magnet M1 does not affect the thickness of the vibrator 2. This is preferable for reducing the height of the vibrator 2.

In an exemplary aspect, the first magnet M1 can protrude from the first accommodation section H1 and may be fixed in this state. For example, the first magnet M1 may be fitted in the first accommodation section H1, which is the piercing section, in such a manner that the first magnet M1 protrudes from at least one of the first and second principal surfaces. In the case of the first accommodation section H1 being a recessed section that opens at the first principal surface of the multilayer body 2a, the first magnet M1 may be fully accommodated inside the first accommodation section H1, or the first magnet M1 may be fitted in the first accommodation section H1 so as to protrude from the first principal surface.

Due to the first magnet M1 being fitted in the first accommodation section H1, the first magnet M1 can be fixed easily to the multilayer body 2a. This configuration enables the magnet to be fixed accurately in the multilayer body 2a.

Referring back to FIG. 2, the first magnet M1 of the linear vibration motor 100 includes five magnet pieces M1a, M1b, M1c, M1d, and Mie that are arrayed in the first direction D1. These magnet pieces are arranged so as to form the Halbach array. The first magnet M1, however, is not limited to this configuration.

It is sufficient that the first magnet M1, which serves as the driving magnet, includes at least one magnet piece to which the coil 3 imparts the driving force for vibrating the vibrator 2. In the case of the first magnet M1 being configured to form the Halbach array, it is sufficient that the first magnet M1 includes at least three or more odd-numbered magnet pieces arrayed in the first direction D1. In the present disclosure, the Halbach array broadly refers to an array of magnet pieces of the driving magnet with which the driving magnet can concentrate the magnetic field into the area between the driving magnet and the coil for driving the vibrator. Accordingly, the number of the magnets included in the Halbach array is an odd number of at least three.

For example, the first magnet M1 may be made of neodymium-iron-boron-based or samarium-cobalt-based rare-earth magnets. It is preferable to use neodymium-iron-boron-based rare-earth magnets for the first magnet M1 because of the strong magnetism that can increase the driving power of the vibrator 2.

As described above, the multilayer body 2a has the groove-shaped second accommodation sections H2 formed at both sides of the multilayer body 2a, the sides extending in the first direction D1. The second accommodation sections H2 include the accommodation section H2a formed at one side of the multilayer body 2a and the accommodation section H2b formed at the other side of the multilayer body 2a. The above-described first sleeve 2b and second sleeve 2c are shaped so as to follow the inside shape of the accommodation section H2a and are fitted in the accommodation section H2a. The first sleeve 2b and the second sleeve 2c may be fixed using, for example, an epoxy-based adhesive.

The first sleeve 2b is fitted in the accommodation section H2a at a position near the third accommodation section H3. The second sleeve 2c is fitted in the accommodation section H2a at a position near the fourth accommodation section H4. Due to the first sleeve 2b and the second sleeve 2c being fitted in the accommodation section H2a, the first sleeve 2b and the second sleeve 2c can be fixed easily to the multilayer body 2a. The fixation of the first sleeve 2b and the second sleeve 2c to the one side of the multilayer body 2a is not limited to the fitting of the sleeves into the accommodation section H2a.

For example, the first sleeve 2b and the second sleeve 2c can be made of a low-friction resin, brass, nickel, or a stainless steel such as SUS304. The low-friction resin is a resin exhibiting a coefficient of kinetic friction of about 0.15 or less against carbon steel in accordance with a thrust-type testing procedure stipulated in JIS K7218. For example, the low-friction resin may include, but is not limited to, a polyphenylene-sulfide-based resin, an aromatic-polyester-based resin or otherwise called a “liquid crystal polymer”, and a polyacetal-based material.

According to an exemplary aspect, the first shaft 4 is slidably inserted and fitted in the first sleeve 2b and in the second sleeve 2c, which means that the first shaft 4 is inserted and fitted in each sleeve so as to have an amount of play controlled within a regular tolerance. The first shaft 4 is thus accommodated in the accommodation section H2a.

The sleeves similar to the first and second sleeves 2b and 2c described above are also fitted in the accommodation section H2b (not illustrated). The second shaft 5 is thereby accommodated in the accommodation section H2b. Due to the sleeves being fitted in the accommodation section H2b, the sleeves can be fixed easily to the multilayer body 2a. The fixation of the sleeves to the other side of the multilayer body 2a is not limited to the fitting of the sleeves into the accommodation section H2b. In an example aspect, the material of the sleeves can be a low-friction resin similar to that of the first sleeve 2b and the second sleeve 2c, for example. The second shaft 5 is slidably inserted and fitted in the above sleeves. The second shaft 5 is thereby accommodated in the accommodation section H2b.

The vibrator 2 engages the first shaft 4 and the second shaft 5 as described above, which regulates the movement of the vibrator 2 and allows the vibrator 2 to move in the first direction D1. The vibrator 2 can be configured to vibrate in the first direction D1 due to the coil 3 (to be described later) imparting the driving force to the first magnet M1 or the driving magnet.

As described above, the multilayer body 2a has the third accommodation section H3 formed at one end of the multilayer body 2a in the first direction D1 and also has the fourth accommodation section H4 formed at the other end of the multilayer body 2a. The second magnet M2 is fixed in the third accommodation section H3 in such a manner that the orientation of the magnetic poles is aligned with the first direction D1. The third magnet M3 is also fixed in the fourth accommodation section H4 in the same manner.

In other words, the second magnet M2 and the fourth magnet M4 are disposed so as to oppose each other and magnetically repel each other, and the third magnet M3 and the fifth magnet M5 are disposed in the same manner. For example, an epoxy-based adhesive can be used to fix the second magnet M2 in the third accommodation section H3 and also used to fix the third magnet M3 in the fourth accommodation section H4.

For example, the second magnet M2, the third magnet M3, the fourth magnet M4, and the fifth magnet M5 are disposed such that the centers of gravity of these magnets are positioned on an identical axis extending in the first direction D1. It is sufficient that the second magnet M2, the third magnet M3, the fourth magnet M4, and the fifth magnet M5 are disposed so as to overlap each other at least partially as viewed in the first direction D1. The second magnet M2 is paired with the fourth magnet M4, and the third magnet M3 is paired with the fifth magnet M5. Thus, these pairs of magnets form a magnetic spring mechanism against the vibration of the vibrator 2 in the first direction D1.

When the thickness of the multilayer body 2a is greater than that of the second magnet M2 and that of the third magnet M3, the thicknesses of the second magnet M2 and the third magnet M3 do not affect the thickness of the vibrator 2. This configuration is preferable for reducing the height of the vibrator 2.

Due to the second magnet M2 being fitted in the third accommodation section H3 and third magnet M3 being fitted in the fourth accommodation section H4, the second magnet M2 and the third magnet M3 can be fixed easily to the multilayer body 2a. This configuration enables accurate fixation of these magnets to the multilayer body 2a. These magnets, however, can be fixed to the multilayer body 2a without forming the third accommodation section H3 and the fourth accommodation section H4.

For example, neodymium-iron-boron-based or samarium-cobalt-based rare-earth magnets may be used for the second magnet M2, the third magnet M3, the fourth magnet M4, and the fifth magnet M5. It is preferable to use samarium-cobalt-based rare-earth magnets for the above magnets because when the temperature changes, the samarium-cobalt-based rare-earth magnets exhibit a small rate of change in magnetism and can stably provide the magnetic spring effect.

As described above, in the first embodiment of the multilayer body 2a included in the weight portion 2W, multiple sheets that include metal sheets are laminated on each other in the thickness direction. Accordingly, the weight portion 2W can be made thinner than the known weight portion manufactured using, for example, the powder metallurgy method. The vibrator 2 of the present disclosure can be made thinner than the known vibrator having the known weight portion. As a result, the linear vibration motor 100 of the present disclosure can be made thinner than the linear vibration motor having the known vibrator.

### Second Exemplary Embodiment of Multilayer Body Included in Vibrator of Linear Vibration Motor

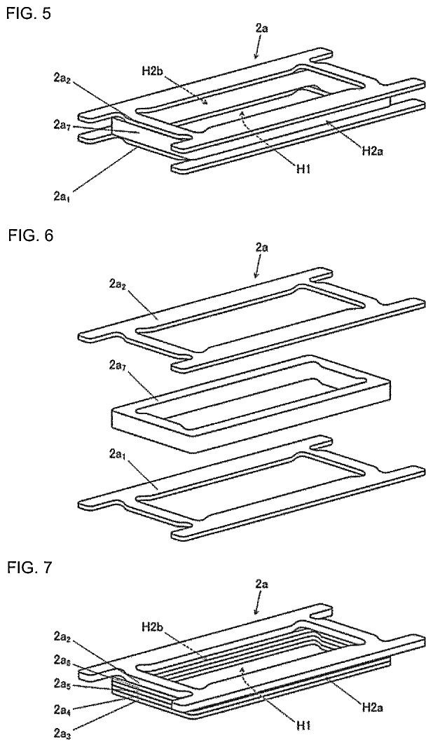

A second exemplary embodiment of the multilayer body 2a included in the vibrator 2 of the linear vibration motor 100 will be described with reference to FIGS. 5 and 6. FIG. 5 is a perspective view illustrating the second embodiment of the multilayer body 2a included in the vibrator 2 of the linear vibration motor 100. FIG. 6 is an exploded perspective view illustrating the second embodiment of the multilayer body 2a. In the second embodiment of the multilayer body 2a, the number of metal sheets having the second pattern and the thickness and the material of each sheet are different from the metal sheets in the first embodiment. Other features are similar to those described in the first embodiment, and duplicated descriptions will be omitted.

As illustrated in FIGS. 5 and 6, the multilayer body 2a of the second embodiment is formed by laminating metal sheets 2a₁ and 2a₂ and a resin-containing sheet 2a₇ in the thickness direction. The resin-containing sheet is configured as described in the first embodiment. The metal sheets 2a₁ and 2a₂ and the resin-containing sheet 2a₇ can be adhered to each other, for example, using an epoxy-based adhesive. It is noted that the sheets may be joined together using a different method as would be appreciated to one skilled in the art.

The shape and the material of the metal sheets 2a₁ and 2a₂ are the same as those of the first embodiment. The metal sheets 2a₁ and 2a₂ are disposed as the outermost layers of the multilayer body 2a at the first and second principal surfaces. The thickness of the metal sheets 2a₁ and 2a₂ is, for example, 0.15 mm. For example, the metal sheets 2a₁ and 2a₂ can be cut out from a base material.

The resin-containing sheet 2a₇ is sandwiched between the metal sheets 2a₁ and 2a₂ and has a shape similar to that described in the first embodiment as viewed in plan. The number of the resin-containing sheets 2a₇ is not limited to one. The thickness of the resin-containing sheet 2a₇ is, for example, 0.80 mm. In other words, the thickness of the resin-containing sheet 2a₇ is greater than the thickness of each of the metal sheets 2a₁ and 2a₂.

For example, the resin-containing sheet 2a₇ can be cut out from a base material. The resin-containing sheet 2a₇ can be cut easily even if the thickness increases, which is preferable.

The multilayer body 2a has the first accommodation section H1, which is the piercing section that opens at both first and second principal surfaces. As described in the first embodiment above, the first accommodation section H1 is not limited to the piercing section. The first accommodation section H1 may have at least one opening at the first principal surface of the multilayer body 2a. In other words, of the metal sheets 2a₁ and 2a₂ having the first pattern, the metal sheet 2a₂ does not necessarily have the piercing section formed in the central portion. Similarly, the resin-containing sheet 2a₇ having the second pattern does not necessarily have the piercing section formed in the central portion. A recessed section may be formed in place of the piercing section.

The shape of the metal sheets disposed as the outermost layers of the multilayer body 2a at the first and second principal surfaces and the shape of the resin-containing sheet sandwiched therebetween are not limited to the above. For example, the metal sheets 2a₁ and 2a₂ and the resin-containing sheet 2a₇ may all have the same shape. A metal sheet may be used in place of the resin-containing sheet 2a₇.

As is the case for the first embodiment, the multilayer body 2a has the groove-shaped second accommodation sections H2 formed at respective sides of the multilayer body 2a, the sides extending in the first direction D1. Moreover, in this aspect, the second accommodation sections H2 include the accommodation section H2a formed at one side of the multilayer body 2a and the accommodation section H2b formed at the other side of the multilayer body 2a. The sleeves similar to those described in the first embodiment are fixed in these accommodation sections using an adhesive. The first shaft 4 and the second shaft 5 engage these sleeves as in the first embodiment.

In the second embodiment of the multilayer body 2a, the thickness of the resin-containing sheet 2a₇ is greater than the thickness of each of the metal sheets 2a₁ and 2a₂. This configuration reduces the number of the laminated sheets that include metal sheets when the multilayer body 2a is manufactured. Accordingly, this configuration also reduces the amount of an adhesive applied between the sheets, which enables further reduction of the thickness of the multilayer body 2a. As a result, the linear vibration motor 100 of the present disclosure can be made even thinner than the linear vibration motor having the known vibrator.

### Third Exemplary Embodiment of Multilayer Body Included in Vibrator of Linear Vibration Motor

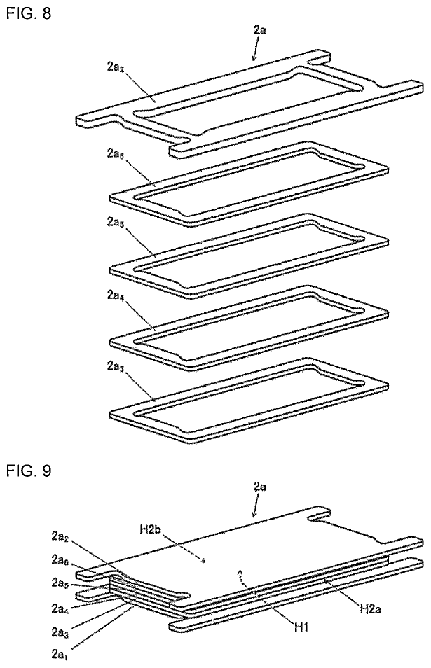

A third exemplary embodiment of the multilayer body 2a included in the vibrator 2 of the linear vibration motor 100 will be described with reference to FIGS. 7 and 8. FIG. 7 is a perspective view illustrating the third embodiment of the multilayer body 2a included in the vibrator 2 of the linear vibration motor 100. FIG. 8 is an exploded perspective view illustrating the third embodiment of the multilayer body 2a. In the third embodiment of the multilayer body 2a, the number of the metal sheets having the first pattern and the thickness of each sheet are different from the metal sheets in the first embodiment. Other features are similar to those described in the first embodiment, and duplicated descriptions will be omitted.

As illustrated in FIGS. 7 and 8, the multilayer body 2a of the third embodiment is formed by laminating, in the thickness direction, the metal sheet 2a₂ and the metal sheets 2a₃ to 2a₆ described in the first embodiment. The metal sheets 2a₂ to 2a₆ can be adhered to each other, for example, using an epoxy-based adhesive. The sheets may be joined together using a different method as described above and would be appreciated to one skilled in the art.

Moreover, the metal sheet 2a₂ has a shape similar to that described in the first embodiment as viewed in plan and is made of a material similar to that in the first embodiment. The metal sheet 2a₂ is disposed as the outermost layer of the multilayer body 2a at the second principal surface. The thickness of the metal sheet 2a₂ is, for example, 0.30 mm. For example, the metal sheet 2a₂ can be cut out from a base material. The metal sheet 2a₂ may be disposed as the outermost layer of the multilayer body 2a at the first principal surface.

The shape and the material of the metal sheets 2a₃ to 2a₆ are the same as those of the first embodiment. The thickness of the metal sheets 2a₃ to 2a₆ is, for example, 0.20 mm. In other words, the thickness of the metal sheet 2a₂ is greater than the thickness of each of the metal sheets 2a₃ to 2a₆. For example, the metal sheets 2a₃ to 2a₆ can be cut out from a base material. It is noted that the number of the metal sheets having the second pattern is not limited to four.

The multilayer body 2a has the first accommodation section H1, which is the piercing section that opens at both first and second principal surfaces. As described in the first embodiment, the first accommodation section H1 is not limited to the piercing section but may have at least one opening at the first principal surface of the multilayer body 2a. In other words, the metal sheet 2a₂ does not necessarily have the piercing section formed in a central portion thereof. In the case of the metal sheet 2a₂ serving as the outermost layer of the multilayer body 2a at the first principal surface, however, the first accommodation section H1 is formed by forming the piercing section in a central portion thereof. In addition, the metal sheets 2a₃ to 2a₆ do not necessarily have the piercing section in respective central portions.

The shape of the metal sheets disposed as the outermost layers of the multilayer body 2a at the first and second principal surfaces and the shape of the metal sheets sandwiched therebetween are not limited to the above. For example, all of the metal sheets 2a₂ and 2a₃ to 2a₆ may have the same shape in an exemplary aspect. It is sufficient that the multilayer body 2a is formed at least by laminating the multiple sheets that include metal sheets.

As is the case for the first embodiment, the multilayer body 2a has the second accommodation sections H2 formed at respective sides of the multilayer body 2a, the sides extending in the first direction D1. In the third embodiment, however, the second accommodation sections H2 are defined by the metal sheet 2a₂ and the side surfaces of the metal sheets 2a₃ to 2a₆. The second accommodation sections H2 include the accommodation section H2a formed at one side of the multilayer body 2a and the accommodation section H2b formed at the other side of the multilayer body 2a. The sleeves similar to those described in the first embodiment are fixed in these accommodation sections using an adhesive. The first shaft 4 and the second shaft 5 engage these sleeves as in the first embodiment.

In the third embodiment of the multilayer body 2a, the metal sheet 2a₂ is the only metal sheet that has the first pattern. This can reduce the number of laminated metal sheets and can also reduce the amount of an adhesive applied between the metal sheets when the multilayer body 2a is manufactured. Accordingly, this configuration can further reduce the thickness of the multilayer body 2a. As a result, the linear vibration motor 100 of the present disclosure can be made even thinner than the linear vibration motor having the known vibrator.

In addition, the thickness of the metal sheet 2a₂ is greater than the thickness of each of the metal sheets 2a₃ to 2a₆. Thus, the thickness of the multilayer body 2a can be reduced, while the first accommodation section H1 can provide a sufficient volume for the first magnet M1 to be accommodated therein, which allows the first magnet M1 to have a sufficient volume.

### Fourth Exemplary Embodiment of Multilayer Body Included in Vibrator of Linear Vibration Motor

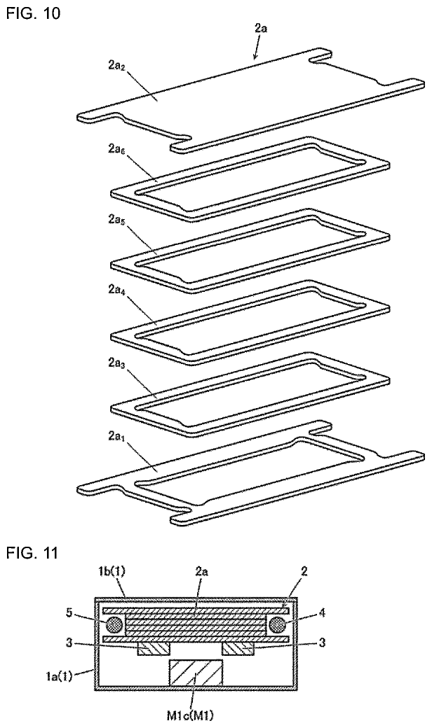

A fourth exemplary embodiment of the multilayer body 2a included in the vibrator 2 of the linear vibration motor 100 will be described with reference to FIGS. 9 and 10. FIG. 9 is a perspective view illustrating the fourth embodiment of the multilayer body 2a included in the vibrator 2 of the linear vibration motor 100. FIG. 10 is an exploded perspective view illustrating the fourth embodiment of the multilayer body 2a. In the fourth embodiment of the multilayer body 2a, the metal sheet having the first pattern and being disposed as the outermost layer of the multilayer body 2a at the second principal surface is made of a material different from that in the first embodiment. Other features are similar to those described in the first embodiment, and duplicated descriptions will be omitted.

As illustrated in FIGS. 9 and 10, the multilayer body 2a of the fourth embodiment is formed by laminating metal sheets 2a₁ and 2a₃ to 2a₆ described in the first embodiment and also laminating the metal sheet 2a₂ in the thickness direction. The metal sheet 2a₂ has the first pattern and is disposed as the outermost layer of the multilayer body 2a at the second principal surface.

It is noted that the metal sheet 2a₂ does not have the piercing section. On the other hand, the piercing section is formed in the metal sheet 2a₁ disposed as the outermost layer of the multilayer body 2a at the first principal surface. The piercing section is also formed in the metal sheets 2a₃ to 2a₆ that are sandwiched between the metal sheets 2a₁ and 2a₂. In other words, the metal sheets 2a₁ and 2a₃ to 2a₆ have the shape similar to those described in the first embodiment. The metal sheets 2a₁ to 2a₆ can be adhered to each other, for example, using an epoxy-based adhesive. Accordingly, the multilayer body 2a has the first accommodation section H1, which is the recessed section that opens at the first principal surface. The sheets may be joined together using a different method.

According to an exemplary aspect, the metal sheet 2a₂ can be made of iron or an alloy containing iron, for example. The metal sheet 2a₂ made of such a material is in contact with the side of the first magnet M1 opposite to the side facing the coil 3. The metal sheet 2a₂ thereby functions as a yoke portion (so called a “back yoke”). The thickness of the metal sheet 2a₂ is, for example, 0.15 mm. For example, the metal sheets 2a₂ can be cut out from a base material.

It is noted that the shape of the metal sheets disposed as the outermost layers of the multilayer body 2a at the first and second principal surfaces and the shape of the metal sheets sandwiched therebetween are not limited to the above. For example, all of the metal sheets 2a₁ and 2a₃ to 2a₆ may have the same shape. Except for the metal sheet 2a₂, the multilayer body 2a may be formed at least by laminating the multiple sheets that include metal sheets.

As is the case for the first embodiment, the multilayer body 2a has the second accommodation sections H2 formed at respective sides of the multilayer body 2a, the sides extending in the first direction D1. The second accommodation sections H2 include the accommodation section H2a formed at one side of the multilayer body 2a and the accommodation section H2b formed at the other side of the multilayer body 2a. The sleeves similar to those described in the first embodiment are fixed in these accommodation sections using an adhesive. The first shaft 4 and the second shaft 5 engage these sleeves as in the first embodiment.

In the fourth embodiment of the multilayer body 2a, the metal sheet 2a₂ is disposed as the outermost layer of the multilayer body 2a at the second principal surface and is in contact with the side of the first magnet M1 opposite to the side facing the coil 3. The metal sheet 2a₂ thereby is configured to function as the yoke portion. The magnetic flux generated by the first magnet M1 is guided to and concentrated in the metal sheet 2a₂. This configuration increases the Lorentz force acting between the first magnet M1 and the coil 3 and accordingly increases the reaction force against the Lorentz force. As a result, the linear vibration motor 100 of the present disclosure can be made thinner than the linear vibration motor having the known vibrator, while the linear vibration motor 100 can generate larger vibrations.

Another Schematic Form of Linear Vibration Motor

A linear vibration motor 100A, which represents another schematic form of the linear vibration motor according to the present disclosure, will be described with reference to FIG. 11. FIG. 11 is a cross-sectional view of the linear vibration motor 100A. The linear vibration motor 100 described above has the structure in which the vibrator 2 has the first magnet M1 and the coil 3 is fixed to the container 1a of the housing 1 so as to oppose the first magnet M1. The linear vibration motor 100A, however, has a structure in which the vibrator 2 has the coil 3 and the first magnet M1 is fixed to the container 1a of the housing 1 so as to oppose the coil 3. It is noted that the linear vibration motor 100A includes the magnetic spring mechanism, as does the linear vibration motor 100.

The linear vibration motor 100A does not have a piercing section formed through multiple sheets of the multilayer body 2a. In other words, the multilayer body 2a does not have the first accommodation section H1 that opens at the first principal surface of the multilayer body 2a, which is different from the linear vibration motor 100. Accordingly, the coil 3 is fixed onto the first principal surface of the multilayer body 2a. The first accommodation section H1, however, can be formed in the multilayer body 2a, and the coil 3 may be fixed in the first accommodation section H1.

Also in the linear vibration motor 100A, the weight portion 2W includes the multilayer body 2a, and the multilayer body 2a is formed by laminating the multiple sheets that include metal sheets in the thickness direction. Accordingly, the weight portion 2W can be made thinner than the known weight portion manufactured using, for example, the powder metallurgy method. The vibrator 2 of the present disclosure can be made thinner than the known vibrator having the known weight portion. As a result, the linear vibration motor 100A of the present disclosure can be made thinner than the linear vibration motor having the known vibrator.

In the linear vibration motors 100 and 100A, the pair of the second magnet M2 and the fourth magnet M4 and the pair of the third magnet M3 and the fifth magnet M5 form the magnetic spring mechanism, and the magnetic spring mechanism transfers the vibration of the vibrator 2 to the housing 1. However, it is noted that the mechanism for transferring the vibration of the vibrator 2 to the housing 1 is not limited to the magnetic spring mechanism. For example, a mechanical spring mechanism using a coil spring or a flat spring can be used in place of the magnetic spring mechanism.

Method of Manufacturing Vibrator of Linear Vibration Motor

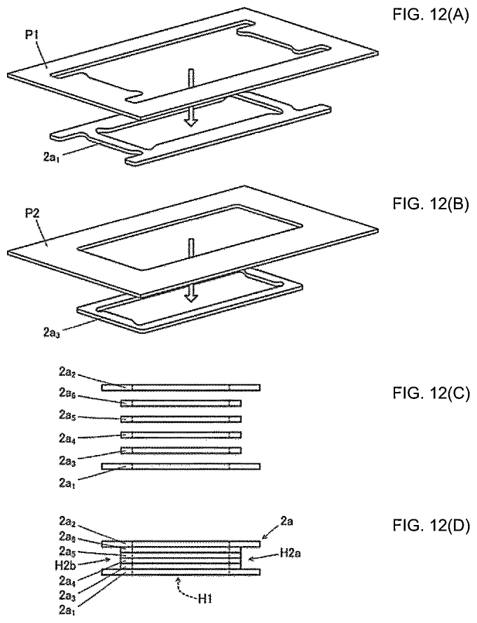

A method of manufacturing the vibrator 2 of the linear vibration motor 100, which is an exemplary embodiment of the linear vibration motor according to the present disclosure, will be described with reference to FIGS. 12(A) to 12(D). FIG. 12(A) is a perspective view schematically illustrating a step of manufacturing the metal sheet 2a₁ having the first pattern. FIG. 12(B) is a perspective view schematically illustrating a step of manufacturing a metal sheet 2a₃ having a second pattern. FIG. 12(C) is a side view schematically illustrating metal sheets 2a₁ to 2a₆ manufactured in the steps of FIGS. 12(A) and 12(B). FIG. 12(D) is a side view schematically illustrating a step of manufacturing the multilayer body 2a by laminating the metal sheets 2a₁ to 2a₆.

The method of manufacturing the vibrator 2 of the linear vibration motor 100 includes a step of preparing or providing multiple sheets including metal sheets, at least one of the multiple sheets having the piercing section formed therethrough. As described above, the multiple sheets includes the metal sheet 2a₁, the metal sheet 2a₂, and the metal sheets 2a₃ to 2a₆. The metal sheet 2a₁ is disposed as the outermost layer of the multilayer body 2a at the first principal surface, and the metal sheet 2a₂ is disposed as the outermost layer of the multilayer body 2a at the second principal surface. The metal sheets 2a₃ to 2a₆ are sandwiched between the metal sheets 2a₁ and 2a₂.

FIG. 12(A) schematically illustrates a step of cutting out the metal sheet 2a₁ from a base material P1. In this step, the metal sheet 2a₁ is prepared so as to have the shape (e.g., having the first pattern and the piercing section) as described in the first embodiment of the multilayer body 2a. For example, the metal sheet 2a₁ can be cut out from the base material P1 by punching using a die or by laser cutting. The metal sheet 2a₂ can be prepared by the same method used for the metal sheet 2a₁. The metal sheet 2a₂ does not necessarily have the piercing section.

For example, the base material P1 may be made of tungsten, an alloy containing tungsten, a stainless steel such as SUS304, or aluminum or an alloy containing aluminum. It is preferable to use a material having a greater specific gravity, such as tungsten or an alloy containing tungsten. The above-described resin-containing sheet may be used as the base material P1 in place of the metal sheet.

FIG. 12(B) schematically illustrates a step of cutting out the metal sheet 2a₃ from a base material P2. In this step, the metal sheet 2a₃ is prepared so as to have the shape (e.g., having the second pattern and the piercing section) as described in the first embodiment of the multilayer body 2a. The metal sheet 2a₃ can be cut out from the base material P2 by the same method used for the metal sheet 2a₁. The metal sheets 2a₄ to 2a₆ can be prepared by the same method used for the metal sheet 2a₃. It is noted that the piercing section is not necessarily formed in the metal sheets 2a₃ to 2a₆. The base material P2 can be made of the same material used for the base material P1 described above.

Thus, the multiple sheets including metal sheets can be prepared or provided through the above steps, and the piercing section is formed through at least one of the sheets. FIG. 12(C) schematically illustrates the metal sheets 2a₁ to 2a₆ manufactured in the steps of FIGS. 12(A) and 12(B).

The method of manufacturing the vibrator 2 of the linear vibration motor 100 also includes a step of forming the weight portion having the multilayer body 2a. In this step, the multilayer body 2a is formed by laminating the above-described multiple sheets in the thickness direction so as to have the first accommodation section H1 that opens at least at the first principal surface.

FIG. 12(D) schematically illustrates a step of preparing the multilayer body 2a by laminating the metal sheets 2a₁ to 2a₆. For example, an epoxy-based adhesive is applied to the metal sheets 2a₂ to 2a₆. The multilayer body 2a is formed by laminating the metal sheets 2a₁ to 2a₆ in the thickness direction in such a manner that the metal sheets 2a₃ to 2a₆ are sandwiched between the metal sheets 2a₁ and 2a₂. These metal sheets are adhered together using the above adhesive.

Thus, the first accommodation section H1, the second accommodation sections H2, the third accommodation section H3, and the fourth accommodation section H4 are formed in the multilayer body 2a. The first accommodation section H1 is the piercing section that opens at both first and second principal surfaces. Moreover, the first magnet M1 is fixed in the first accommodation section H1. The first shaft 4 and the second shaft 5 are accommodated in respective second accommodation sections H2. The second magnet M2 is fixed in the third accommodation section H3. The third magnet M3 is fixed in the fourth accommodation section H4.

According to an exemplary aspect, the weight portion can be formed by fixing necessary members for engagement with the shafts (not illustrated) to the multilayer body 2a. For example, the members include the first sleeve 2b and the second sleeve 2c of FIG. 2. A separate weight member may be attached to the multilayer body 2a.

As described above, the metal sheet 2a₂ does not necessarily have the piercing section formed in a central portion thereof. Moreover, the metal sheets 2a₃ to 2a₆ having the second pattern may include a metal sheet that does not have the piercing section formed in the central portion. In this case, the first accommodation section H1 becomes the recessed section that opens at the first principal surface of the multilayer body 2a.

Thus, the weight portion including the multilayer body having the first accommodation section opening at least at the first principal surface can be prepared, through the above steps, by laminating the multiple sheets in the thickness direction.

According to the method of manufacturing the vibrator 2 of the linear vibration motor 100, the weight portion with a reduced thickness can be manufactured easily. The metal sheets are cut out from the base material, which can reduce the tact time and thereby improve the productivity. Manufacturing metal sheets using the punching method can increase the number of metal sheets easily and can further improve the productivity. Moreover, it is noted that the above manufacturing process does not include a sintering step, which leads to the reduction of the manufacturing cost.

In the method of manufacturing the vibrator 2 of the linear vibration motor 100A, the multilayer body 2a is formed by laminating the metal sheets 2a₁ to 2a₆ that do not have piercing sections. In this case, the multilayer body 2a does not have the first accommodation section H1 that opens at the first principal surface of the multilayer body 2a, which is different from the linear vibration motor 100. In this case, the coil 3 is fixed onto the first principal surface of the multilayer body 2a. The piercing section may be formed through the metal sheet 2a₁ disposed as the outermost layer of the multilayer body 2a at the first principal surface. The piercing section may also be formed through at least one of the metal sheets 2a₃ to 2a₆. The multilayer body 2a having the first accommodation section H1 may be obtained by laminating these metal sheets, and the coil 3 may be fixed in the first accommodation section H1.

Schematic Form of Electronic Device

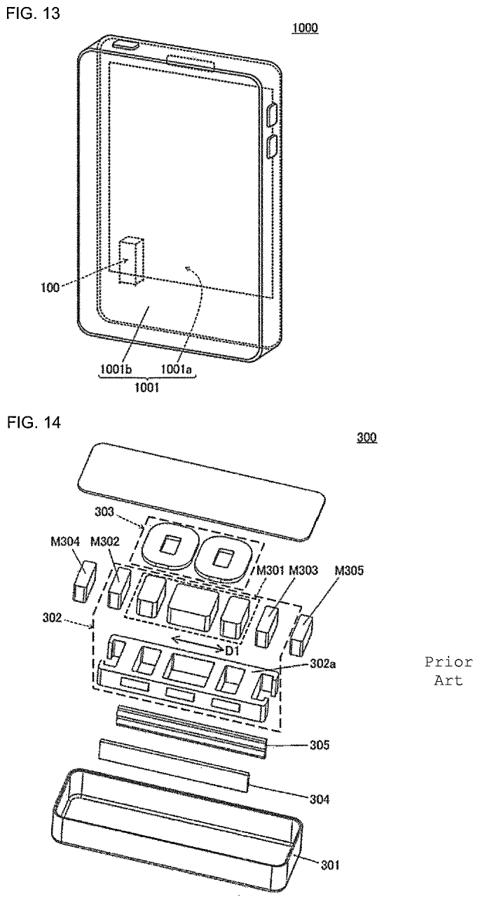

A portable information terminal 1000 will be described with reference to FIG. 13. The portable information terminal 1000 represents a schematic form of an electronic device containing the linear vibration motor according to the present disclosure.

In particular, FIG. 13 is a transparent perspective view of the portable information terminal 1000. The portable information terminal 1000 includes a device housing 1001, the linear vibration motor 100 according to the present disclosure, and an electronic circuit (not illustrated) related to transmission and reception of signals and data processing. The device housing 1001 includes a first portion 1001a and a second portion 1001b. The first portion 1001a is a display, and the second portion 1001b is a frame. The linear vibration motor 100 is accommodated inside the device housing 1001.

The portable information terminal 1000 includes the linear vibration motor 100 according to the present disclosure, and the linear vibration motor 100 serves as a vibration generating device for providing cutaneous sensation feedback or for confirming keystrokes or noticing incoming calls using vibration. It is noted that the linear vibration motor used for the portable information terminal 1000 is not limited to the linear vibration motor 100 but may be any type of the linear vibration motor according to the present disclosure.

The linear vibration motor of the present disclosure can be made thinner since the linear vibration motor includes the vibrator having the weight portion of which the thickness is reduced. The portable information terminal 1000 uses the linear vibration motor of the present disclosure and accordingly can be made thinner.

The portable information terminal that includes a display has been described as a schematic example of the electronic device in which the linear vibration motor of the present disclosure is used. However, it should be appreciated that the electronic device of the present disclosure does not necessarily include the display.

Examples of the electronic device of the present disclosure include a mobile phone (so called a feature phone), a smart phone, a portable video game console, a video game controller, a virtual reality system controller, a smart watch, a tablet computer, a laptop computer, a remote controller for a TV set or the like, a touch panel display for an automatic teller machine or the like, and electronic devices of various toys.

In general, it is noted that the embodiments disclosed herein are examples, and the invention according to the present disclosure is not limited to the above embodiments and modification examples. In other words, the exemplary embodiments of the present invention can be subjected to various modifications and alterations insofar as not departing from the above scope.

Moreover, the invention according to the present disclosure is applied to a linear vibration motor to be used, for example, in a vibration generating device of an electronic device for providing cutaneous sensation feedback or for confirming keystrokes or noticing incoming calls using vibration. An example of the cutaneous sensation feedback is that the vibration of the controller reproduces touch feelings associated with an action in a video game (such as opening or closing a door or turning the steering wheel of a car). The cutaneous sensation feedback is not limited to this.

The invention according to the present disclosure can be applied to a linear vibration motor to be used as an actuator of a robot.

### REFERENCE SIGNS LIST

100 linear vibration motor
1 housing
2 vibrator
2a multilayer body
2W weight portion
3 coil
4 first shaft
5 second shaft
H1 first accommodation section
H2 second accommodation section
M1 first magnet

1. A linear vibration motor, comprising:
a housing; and
a vibrator that is accommodated in the housing and that includes a weight portion having a multilayer body with a first principal surface and a second principal surface opposite to the first principal surface,
wherein the multilayer body has a plurality of sheets laminated in a thickness direction of the vibrator, with the plurality of sheets including at least one metal sheet.

2. The linear vibration motor according to claim 1, further comprising:
a coil fixed to the housing,
wherein the multilayer body comprises a first accommodation section that opens at least at the first principal surface, and
wherein the vibrator includes a first magnet that is fixed in the first accommodation section so as to oppose the coil.

3. The linear vibration motor according to claim 2, wherein the first magnet is disposed inside the first accommodation section.

4. The linear vibration motor according to claim 1, further comprising:
a first magnet,
wherein the vibrator further includes a coil, and the first magnet is fixed to the housing so as to oppose the coil.

5. The linear vibration motor according to claim 1, further comprising:
a shaft that supports the vibrator inside the housing so as to configure the vibrator to vibrate; and
an accommodation section disposed at a side of the multilayer body that extends in a direction of vibration of the vibrator during excitation,
wherein the shaft is disposed in the accommodation section.

6. The linear vibration motor according to claim 2, wherein:
the plurality of sheets include a metal sheet having a first pattern and metal sheets or resin-containing sheets having a second pattern, and
the metal sheet having the first pattern is disposed as at least one outermost layer of the multilayer body at at least one of the first principal surface and the second principal surface.

7. The linear vibration motor according to claim 6, wherein an area defined by an outer periphery of the metal sheet having the first pattern is greater than an area defined by an outer periphery of the metal sheets or resin-containing sheets having the second pattern.

8. The linear vibration motor according to claim 7, wherein:
a piercing section is formed through the metal sheet having the first pattern and is disposed as the at least one outermost layer of the multilayer body at the first principal surface,
the piercing section is also formed through at least one sheet of the metal sheets or resin-containing sheets having the second pattern, and
the piercing section is configured as the first accommodation section.

9. The linear vibration motor according to claim 7, wherein:
the metal sheet having the first pattern is disposed as each of the outermost layers of the multilayer body at the first principal surface and at the second principal surface, respectively, and
a thickness of each of the metal sheets or resin-containing sheets having the second pattern is equal to or greater than a thickness of the metal sheet having the first pattern.

10. The linear vibration motor according to claim 7, wherein:
the metal sheet having the first pattern is disposed as one of the outermost layers of the multilayer body at at least one of the first principal surface and the second principal surface, and
a thickness of the metal sheet having the first pattern is equal to or greater than a thickness of each of the metal sheets or resin-containing sheets having the second pattern.

11. The linear vibration motor according to claim 1, wherein the plurality of sheets contain tungsten.

12. The linear vibration motor according to claim 8, wherein:
the metal sheet having the first pattern is disposed as each of the outermost layers of the multilayer body at the first principal surface and at the second principal surface, respectively,
the piercing section configured as the first accommodation section is formed through the metal sheet having the first pattern and being disposed as the outermost layer of the multilayer body at the first principal surface, the piercing section also being formed through the metal sheets or resin-containing sheets having the second pattern, and
the metal sheet having the first pattern and being disposed as the outermost layer of the multilayer body at the second principal surface is configured as a yoke portion through which magnetic flux generated by the first magnet is guided.

13. The linear vibration motor according to claim 12, wherein:
the metal sheet having the first pattern and being disposed as the outermost layer of the multilayer body at the first principal surface contains tungsten,
the metal sheets or resin-containing sheets having the second pattern contain tungsten, and
the metal sheet having the first pattern and being disposed as the outermost layer of the multilayer body at the second principal surface contains iron.

14. The linear vibration motor according to claim 1, wherein:
the vibrator further includes a second magnet and a third magnet,
the housing has a fourth magnet and a fifth magnet fixed thereto,
the second magnet opposes the fourth magnet so as to magnetically repel each other, and
the third magnet opposes the fifth magnet so as to magnetically repel each other.

15. An electronic device, comprising:
the linear vibration motor according to claim 1; and
a device housing, wherein the linear vibration motor is accommodated inside the device housing.

16. A vibrator comprising:
a weight portion that includes a multilayer body having a first principal surface and a second principal surface opposite to the first principal surface,
wherein the multilayer body has a plurality of sheets laminated in a thickness direction, and
wherein the plurality of sheets include at least one metal sheet.

17. The vibrator according to claim 16, wherein a first accommodation section is disposed in the multilayer body so as to open at least at the first principal surface.

18. A method of manufacturing a vibrator, the method comprising:
providing a plurality of sheets that include at least one metal sheet; and
laminating the plurality of sheets in a thickness direction to form a weight portion that includes a multilayer body having a first principal surface and a second principal surface opposite to the first principal surface.

19. The method of manufacturing the vibrator according to claim 18, wherein the plurality of sheets includes a metal sheet having a first pattern and metal sheets or resin-containing sheets having a second pattern.

20. The method of manufacturing the vibrator according to claim 19, further comprising:
forming a piercing section through the metal sheet having the first pattern and being disposed as an outermost layer of the multilayer body at the first principal surface;
forming the piercing section through at least one sheet of the metal sheets or resin-containing sheets having the second pattern; and
configuring the piercing section as a first accommodation section.
